(19) United States
(12) Patent Application Publication
(10) Pub. No.: US 2002/0129164 A1
(43) Pub. Date: Sep. 12, 2002

(54) Advanced path checker

(75) Inventors: Pieter Sierd Van Der Meulen, Sunnyvale, CA (US); Gregory Robert Roelofs, San Jose, CA (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/801,173

(22) Filed: Mar. 5, 2001

(51) Int. Cl. G06F 15/173

(52) U.S. Cl. 709/239

(57) ABSTRACT

On a Web document a user interface element such as a link or hypertext link is associated with a first path leading to a first resource. Similarly in a list of bookmarks, a bookmark is associated with a first path leading to a first resource. If the first path is invalid, the element is associated with a valid sub-path of the first path. A visual indicator may be caused to indicate the level of validity of the first path. The first path associated with the element may be replaced by the valid sub-path. The first path may comprise a series of hierarchical locations on a network. The sub-path may be derived from the original path by going up at least one location in the series of hierarchical locations.

### FIELD OF THE INVENTION

The invention relates to a method of checking a validity of a first path indicating a first resource in a network.

The invention also relates to a device allowing checking a validity of a first path indicating a first resource in a network.

The invention further relates to a computer program comprising computer readable instructions for carrying out such a method. The invention can be integrated as a plug-in for adding a new functionality into an existing Web browser and helping an individual to manage a collection of uniform resource locators (URL). The invention may also be integrated in the core application of a browser. The invention can also be applied in a server to check the validity of hyperlinks of content information.

### BACKGROUND ART

Retrieval of information over the Web is generally achieved by the use of a browser compatible with HTML (Hyper Text Markup Language) such as NETSCAPE NAVIGATOR of NETSCAPE or INTERNET EXPLORER of MICROSOFT. A network path to a resource or document on the Internet is identified by a URL having a specific syntax defining the location of the resource in the network. The URL is often composed of a series of hierarchical locations on the Web. The entry of a URL in the entry field of the browser can be a difficult task and a burden for an individual. This is particularly true for a URL that an individual often uses. The individual will find cumbersome to repeatedly enter the same URL. Therefore, Web browsers offer many functions in the user interface to create a list of bookmarks or favorites allowing saving links comprising the relevant URLs. A bookmark or a favorite is therefore a saved link. A simple way to add a bookmark or favorite for a given URL to a collection of bookmarks or favorites is to first execute the URL. Once the resource indicated by the URL is retrieved, the individual may open the bookmark menu in the browser interface and the individual may add the bookmark by selecting the menu option “Add bookmark”. The bookmark may also be added by a keystroke. These saved links or user interface elements may expire over time and, as a result, selection by the individual of these user interface elements would lead to an error message.

Furthermore, the Web is comprised of inter-linked Web sites. A Web site is a collection of Web files such as Web pages, possibly on a particular subject, that includes a beginning file called a home page. A Web page is a file notated with HTML. Usually, a Web page comprises text, specifications about where image or other multimedia filed are to be placed when the page is displayed. In the following, a Web page also refers to the page displayed to the user. A page may be referred to as a graphical user interface comprising a collection of user interface elements that an individual can select. Such elements can be links associated with respective URLs indicating other Web pages.

Several methods and software applications such as plug-ins are available to help an individual to manage a collection of user interface elements like bookmarks or hypertext links.

U.S. Pat. No. 6,041,360 discloses such a method. This document describes providing access to the Internet by the use of dynamic bookmarks. A first bookmark is stored in a browser in a computer system, the first bookmark referencing a web page at a Uniform Resource Locator. A dynamic attribute is set for the first bookmark to keep it updated. When a change is detected in the web page data incorporated in the first bookmark, it is automatically updated by virtue of its dynamic attribute to reflect the change in web page data. The change in web page data can be detected during a request for the web page referenced by the first bookmark. For example, if redirection of the request to a new URL is detected, the first bookmark is updated to a new URL. A new request for the web page is issued using the new URL.

In addition, numerous software applications are now widely available that allow checking the validity of URLs. Some applications may permit checking the validity of stored bookmarks. These applications, when activated, request a bookmarked URL on a regular basis from a web server and use the result code returned by the web server to determine whether the stored URL is valid or not. For example, result code 403 and 404 will be interpreted as an invalid URL. An invalid bookmark will be indicated as such and may be automatically erased from the collection or proposed to the individual for suppression. Some applications may also check the validity of URLs on a Web page or on a Web site. These applications are often referred to as link checkers. A link checker is a program that tests and reports on the validity of the hyper-text links on the pages in a Web site. More advanced link checkers test links to other Web sites as well as links between pages on the same Web site. A link checker may be a separate program that specializes in this service, such a plug-in integrated in the Web browser, part of a larger program that provides a range of Web site publishing services, or provided periodically as a service from a remote application server.

### SUMMARY OF THE INVENTION

It is an object of the invention to provide an alternate method that enables efficient update of a user interface element with time.

It is an object of the invention to provide a refined checking of a path associated with a user interface element that provides a user with another path leading to an alternate location where the individual may eventually find desired information.

To this end, a method of the invention comprises:

providing the first path to a server to retrieve the first resource from the network;

receiving a first response from the server;

from the first response, determining the validity of the first path; and if the first path is invalid,

(i) generating a second path from the first path, the second path being a sub-path of the first path.

In a method of the invention, the user interface element is associated with the first path leading to the first resource in the network. As time goes, the first path associated with the element may expire or become invalid and a method of the invention allows detecting that the first path is not longer valid. To this end, the server is requested to retrieve the first resource that can supposedly be located in the network from the first path. The server sends a first response back that may indicate whether the server was able to retrieve or locate the first resource. Thus, from this first response, the first path is held valid or invalid. If the first path is held invalid, the inventors have realized that a second path can be generated from the first path as a sub-path of the first path. In an embodiment, the first path comprises a series of hierarchical location in the network and the second path may be obtained by removing the lower hierarchical location from the first path. The second path may be considered as an alternative to the first path that became invalid. An advantage of one or more embodiments of the invention is to allow efficient maintenance and validity verification of user interface elements in content information.

In another embodiment, a method of the invention further comprises:

(ii) providing the second path to the server to retrieve from the network a second resource indicated by the second path;

(iii) receiving a second response from the server;

(iv) from the second response, determining a validity of the second path; and, if the second path is valid,

associating the second path with a user interface element associated with the first path; if the second path is invalid,

repeating steps (i) to (iv) to determine a validity of at least a sub-path of the second path until a specific sub-path of the second path is valid; and,

associating the specific sub-path with the user interface element.

In this embodiment, the server is also requested to retrieve the second resource. There, again, a second response is received from the server and this second response indicates whether the second path is valid. If the second path is found valid, the second path is associated with the user interface element. The first path associated with the element is not necessarily replaced by the second path. Indeed, the element may be associated with, both, the first path and the second path. The second resource may be proposed to the user as an alternative to the first resource for which the first path has expired. If the second path is also invalid, the method is reiteratively performed until a specific path, being a sub-path of the second path and also a sub-path of the first path is valid, if any can be found. If a specific path is valid, this specific path is associated with the element. An advantage of the invention is to allow efficient and dynamic update of a user interface element.

In another embodiment of the invention, the method further comprises:

causing a display of a first visual effect to represent a level of validity of the first path.

In this embodiment, a level of validity is associated with the first path. The level of validity is consequently associated with the user interface element. The first path or the element may be said to be fully valid if the first path is a valid path. The first path or the element may be said to be of a lesser validity if the first path is invalid but a sub-path of the first path can be found valid. The first visual effect enables the individual to immediately measure the validity level of the element. For example, a fully valid element is indicated in green and an element for which no sub-path can be found valid is indicated in red. Other user interface elements having partial valid sub-paths may be indicated using various shades between green and red.

### BRIEF DESCRIPTION OF THE DRAWINGS

The invention is explained in further detail, by way of example, and with reference to the accompanying drawing wherein:

FIG. 1 is a flow-chart of a method of the invention;

FIG. 2, FIG. 3 are displays of bookmark menus of a Web browser according to the invention; and,

FIG. 4 is device of the invention.

Elements within the drawings having similar or corresponding features are identified by like reference numerals.

### PREFERRED EMBODIMENT

In the following paragraphs, embodiments of the invention are given with respect to user interface elements associated with paths leading to resources over the Web.

A user interface (UI) element may be a user-selectable link on a Web page or a saved bookmark in a Web browser.

As used herein, “bookmark” indicates a saved link to a resource that has been added to a list of saved links. A link is a selectable connection from one word, a string of words or any graphical user interface element to a resource. A link allows an individual to quickly get to the Web resource indicated by the link. A user interface (UI) element is associated with a path to a resource over the network. The element is often displayed as a word or string of words having more meaning for the individual than the path itself. The element may also be a graphical representation, e.g. an icon.

In the context of the Internet, the path may be a Uniform Resource Identifier (URI). A URI is the way a resource or point of content is identified over the Internet, whether the resource is a page of text, a video or sound clip, a still or animated image or a program such as a Java applet. The most common form of a URI is the Web page address called a URL (Uniform Resource Locator). An e-mail address is also a URI. A URI typically describes the mechanism used to access the resource, the specific computer over the Internet where the resource is housed in and also indicates the specific name of the resource on the computer. For example, the URL “http://www.hostcomputer.com/locations1/location2/resourceA.html” identifies the Web page “resourceA” that can be accessed using the Web protocol application Hypertext Transfer Protocol (HTTP). The resource is hosted on a computer identified by “hostcomputer” and on this computer, the resource is located at “location1/location2/”.

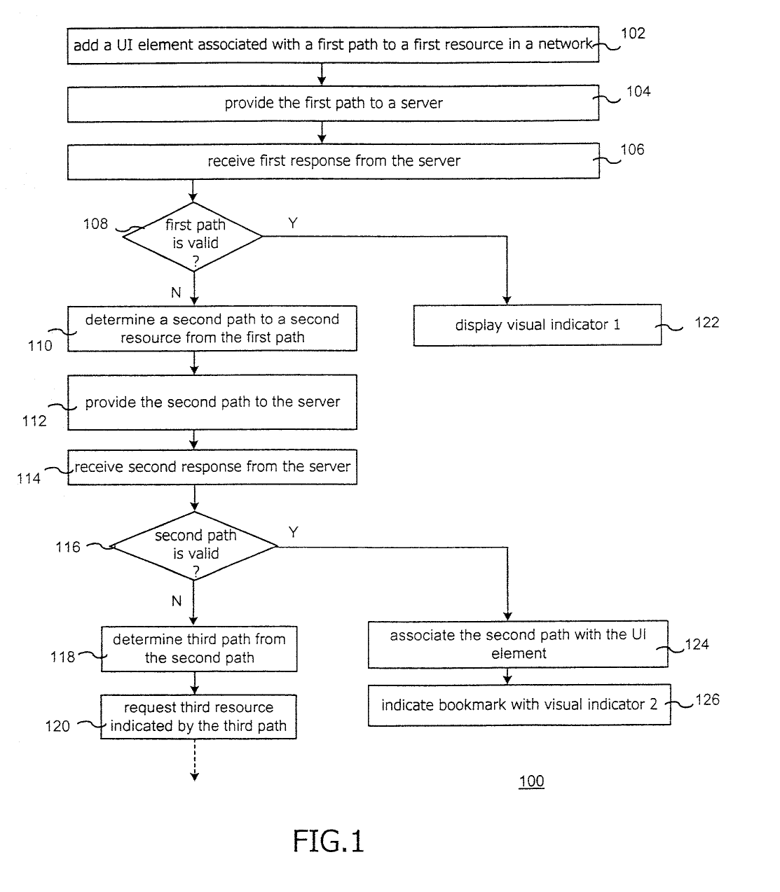

FIG. 1 is a flow-chart 100 of a method of the invention. FIG. 1 depicts a method of the invention applied within the framework of a Web browser. In this embodiment, the considered UI element is a bookmark. In a first step 102, an individual adds a UI element to a collection of already saved UI elements. The UI element is initially associated with a first path to a first resource at a given location on the Web. The UI element may be added by first browsing the Web, identifying and retrieving a Web page that is interesting to the individual. Once the Web page is retrieved, the individual selects the option “bookmarks” in the browser menu and selects the option “add bookmark”. The individual may then be asked for a string of words to identify the UI element. These words will be the ones displayed to the individual for identifying the UI element in the list. The first path to the Web page is stored in a UI table in a storage medium and the first path stored in the table is associated with the UI element. Later, the individual can select the UI element by means of a cursor or by keystroke to automatically go to the Web page. Alternatively, the UI element can be added to the list of saved UI elements without the individual intervention. Indeed, a Web browser often includes an application that creates a set of standard bookmarks, e.g. when the browser is originally installed on a workstation or a personal computer.

In a step 104, the browser provides the first path to a server to retrieve the first resource from the network. Step 104 may comprise the browser requesting the server to retrieve the first resource. Such a request may be done automatically on a regular basis or upon user activation. To this end, the browser sends a request comprising the first path to the server for the first resource, e.g. an HTTP HEAD or GET request. Therefrom, the server checks the validity of the first path by determining whether the first resource exists at the location indicated by the first path. The server can be a proxy server, a cache server, an edge server or a remotely located server on the Internet. The server may contact a server application program of the computer hosting the first resource and the server receives a first response back exposing whether the first resource exists, whether the first resource has been removed and in case the first resource has been moved indicating the new location of the resource.

Therefrom the server sends a first response back to the browser as mentioned in step 106. For example, a 200 HTTP response signifies a successful transmission and that the first resource can be located. A 302 HTTP response signifies that the first resource has moved and redirects to a new URL on the Internet. A 304 HTTP response signifies that the first resource can be retrieved from the cache server. A 401 HTTP response signifies that the individual is not authorized to access the first resource. A 403 HTTP response that access is denied to the first resource. A 404 HTTP response signifies that the first resource cannot be found. A 500 HTTP resource signifies an error at the server side; this is not a meaningful response as to whether the first resource can be retrieved.

Therefrom, the browser determines in step 108, whether the first path associated with the UI element is valid or not.

In case the first path is held valid from the first response, the browser in step 122 identifies the UI element using a visual indicator 1. For example, the UI element is displayed with green characters or a green flag is inserted in the display next to the UI element. Thus, the individual knows that the bookmark is fully valid and still leads to the first resource.

In case the browser holds the first path invalid from the first response, the browser in step 110 determines a second path from the first path. The second path is a sub-path of the first path. The first path may be comprised of a series of at least one hierarchical location over the network. For example, let us assume that the first path is “location1/location2/location3/resource_name” with locations being a location on the network, location2 being a hierarchically sub-location in locations, location2 being a hierarchically sub-location in location2 and resource_name being the name of the first resource and also a hierarchically sub-location in location3. The second path may be location1/location2/location3 which would lead to a second resource such as a default document at location3. Thus, step 110 may comprise navigating up at least one location in the first path being for example a URL.

In step 112, the browser provides the second path to the server to retrieve the second resource. To this end, as described in step 104, the browser may send an HTTP GET request to the server for the second resource. However, the browser may contact a different server to retrieve the second resource as the one the browser contacted to retrieve the first resource in step 104. In step 114, the Web browser receives a second response back from the server exposing whether the second resource can be retrieved at the location indicated by the second path.

From the second response, the browser determines in step 116 whether the second path is valid, e.g. whether the second path leads to an existing second resource such as a default document.

In case the second path is held valid, the browser, in step 124, associates the UI element with the second path. Thus, in an embodiment, the UI element is associated with both the first and the second paths. Alternatively, the second path replaces the first path, e.g. in the UI table, so that henceforth the UI element is associated with the second path leading to the second resource. Thus, thereon when the individual selects the UI element, the second resource is retrieved and executed. In step 126, the browser identifies the UI element with a visual indicator 2. For example, the UI element is displayed using orange characters.

In case the second path is held invalid, the browser in step 118 determines a third path obtained from the second path. The third path is a sub-path of the second path and therefore a sub-path of the first path also. For example, the browser navigates up another location in the second path as shown in step 110. The third resource may indicate a third resource on the network. The browser then sends a request to the server for the third resource. The browser receives a third response from the server and determines from this third response whether the third path is valid.

Step 116, 118 and 122 are performed for the third path and till a specific path is held valid. Once the specific path is found, if any exists, the specific path is associated with the UI element. In addition, the UI element is visually identified with a specific visual indicator that represents a level of validity of the first path. For example, bookmarks in a list of bookmarks may be visually ranked or listed according to their determined level of validity. Thus, the bookmarks for which the respective first paths are still fully valid may be placed first in the list of bookmarks. These bookmarks may be followed by the ones for which the respective first paths are invalid but for which the respective second paths are valid, the second paths being obtained by going up only one location in the respective first paths and so on. In this embodiment, the visual effect that was caused to indicate the level of validity of the first path is the ranking of the UI element, the bookmark, in the list of bookmarks.

The visual indicators 1 and 2 represent respective levels of validity of the first path as will be shown hereinafter. According to an embodiment of the invention, the first path associated with the UI element may have been replaced by the specific sub-path of the first path that has been found valid. In this embodiment, the visual indicators inform the individual whether the UI element still links to the first resource and in case it does not, the indicators may indicate how far the resource, to which the UI element is now linking, is from the first resource.

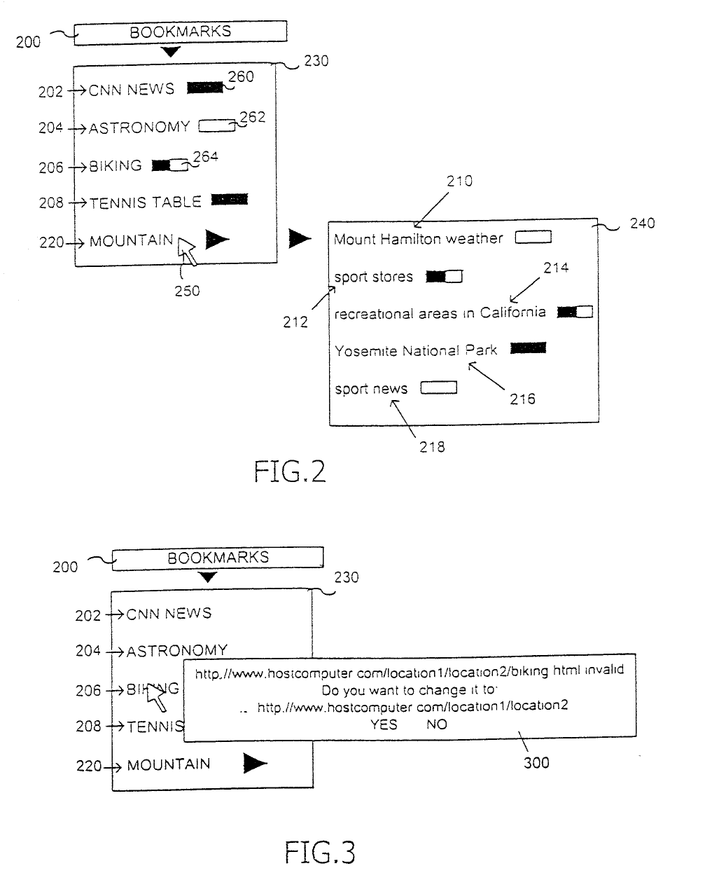

FIG. 2 and FIG. 3 show bookmarks lists of a Web browser to which the method of the invention has been applied. FIG. 2 shows a bookmark menu 200. This menu 200 comprises a list 230 of bookmarks 202-218. The bookmarks 202-218 are user selectable UI elements. The menu 200 comprises a main list 230 comprising the four bookmarks 202-208 and a link 220 to a sub-list 240. The sub-list 240 comprises the five bookmarks 210-218. Each bookmark 202-218 is initially associated with a respective first path that was stored at the time the bookmark was added to the list 230. In this embodiment, the first path is the URL of the Web page that was bookmarked. The individual seeking to use one of the bookmarks 202-218 may select one of the bookmarks 202-218 with the arrow cursor 250. In this embodiment, a visual effect is caused so as to indicate the level of validity of the respective paths associated with the bookmarks 202-218. Thus, in this embodiment, visual indicators 260, 262 and 264 is displayed next to each bookmark 202-218 so as to represent the level of validity of the first path associated with the bookmark 202-218. The visual indicator is here a graphical “gauge” that can show three different filling levels leading to three different indicators 260, 262 and 264. The indicators 260-264 may be colored. The indicator 260 is a full gauge that, when associated with a bookmark, indicates a full validity of the first path initially associated with the bookmark. Thus in this embodiment, each bookmark 202, 208 or 216 is still associated with the first path. Each bookmark 202, 208 and 216 leads to the first resource. The indicator 262 is a half-filled gauge that, when associated with a bookmark, indicates that the first path associated with the bookmark is not valid but that a sub-path of the first path can be found valid. In this embodiment, the bookmarks 206, 212 and 214 are no longer associated with the respective first paths but are associated with valid sub-paths of the respective first paths. The indicator 264 is an empty gauge that when associated with a bookmark, indicates that the first path is invalid and that no sub-path of the first path is valid. Thus, the first paths associated with the bookmarks 204, 210 and 218 are no longer valid paths and no-sub paths of these first paths can be found valid. The invalid first paths may not have been replaced for these bookmarks 204, 210 and 218 since no valid sub-path for these first paths could be found.

FIG. 3 is another embodiment of the invention. FIG. 3 shows the bookmark menu 200 with the bookmarks 202-208 and the link 220 to the sub-list 240 of other bookmarks not shown here. In this embodiment, the level of validity of a specific bookmark 202-208 is displayed when the cursor 250 is placed on the bookmark 202-208. The level of validity of a given bookmark 202, . . . , or 208 is here shown in a dialog box 300 that pops up when the cursor points to the bookmark 202, . . . , or 208. In the box 300, the first path associated with the bookmark is shown and the level of validity of the bookmark is indicated. If the first path is invalid, a specific valid sub-path may also be indicated and proposed for replacement of the first path. If no valid sub-path of the first path exists, the box 300 may also indicate so. In this embodiment, the cursor 250 indicates the bookmark 206. The box 300 indicates that the first path http://www.hostcomputer.com/locations/location2/biking.html” is no longer valid. According to the invention a specific valid sub-path, if any exists, is associated with the bookmark 206. This valid sub-path “http”//www.hostcomputer.com/location1/location2” leading to a default resource is also provided in the box 300 and proposed for replacement for the first path, now invalid. From the information presented in the box 300, the individual can determine for a given UI element the level of validity of the first path.

Alternatively, the level of validity of a UI element may be indicated by other graphical or combination of visual effects and audio effects for example. For example, a color code may be established and a UI element may be shaded or colored so as to indicate a specific level of validity. Similarly, a transparency filter may also be used so that the UI element gradually disappears when the validity level of the first path associated with the UI element decreases.

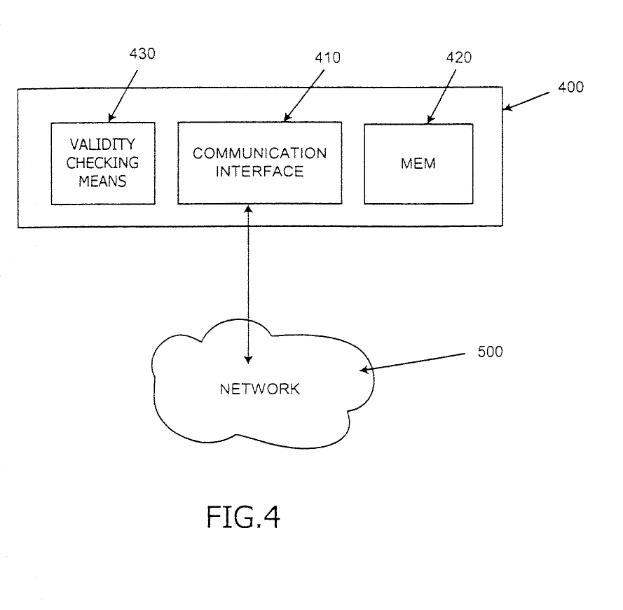

FIG. 4 is an embodiment of a device 400 of the invention. The device 400 comprises a communication interface 410 enabling communicating over a network 500. The interface 410 may comprise a Web browser that enables the individual to access resources over the Internet and communicate over the Internet. The device 400 comprises a storage medium 420 enabling the individual to store a list of paths associated with UI elements. The storage medium 420 may also be an external component on the network 500 that can be accessed remotely from a Website for example. The device 400 also comprises validity checking means 430 that determine the validity, according to a method of the invention, of the paths associated with the UI elements, the paths being stored in the storage medium 420. The application run in the validity checking means 430 may be implemented as a plug-in integrated in the Web browser of the communication interface 410 or integrated in the core application of the Web browser. The validity checking means 430 is coupled to the interface unit 410 and may be capable of operating capabilities of the communication interface 410 such as causing the Web browser of the interface 410 to send an HTTP HEAD or GET request for a given resource indicated by a path. Thus, the validity checking means 430 may be configured to automatically and on a regular basis check the validity and thereby update one or more UI elements of the elements stored in the storage medium 420 according to a method the invention. The validity checking means 430 may also update one or more UI elements upon request from the individual. In another embodiment, the communication interface 410 may be built in the validity checking means 430. The device 400 is for example a personal computer, or a set-top box enabling access to the Internet. The device 400 may also comprise a display or may be coupled to a display for displaying the UI elements.

Such a method of the invention may also be used at a server-side for checking the validity of one or more links on a page of a Web site hosted by the server. The server may be a distributed server. A method of the invention may be proposed as a service that is carried out by a computer program that regularly checks the validity of UI elements such as links of a given Web page or Web site. According to the invention, the computer program associates the UI element with a valid sub-path of the first path. The computer program may also propose the owner or manager of a Web page to replace the first path with the valid specific sub-path. Thus, the method may be carried out in a server for checking the validity of an hyperlink in a given Web page. The server requests another server to retrieve the resource indicated by the hyperlink. The server receives a response from this other server and therefrom determines the validity of the hyperlink according to the invention. In case the hyperlink indicates a resource locally stored at the server, the server retrieves the resource internally without requesting another remote server.

Therefore, in another embodiment, the device 400 comprises a computer hosting a server being a computer program that executes and fulfills requests from clients. The device 400 may allow checking the validity of hyperlinks of a Web page hosted in the device 400. For example, the device 400 may be a Web server that allows continuous validity checking of the UI elements, such as hyperlinks, of Web content being hosted at the server side as a maintenance service. It is also within the scope of the invention that the Web page or the content information comprising the UI elements that are being checked according to a method of the invention is hosted in a remote different computer or remote database. The device 400 may be any device comprising a Web browser or a Web server.

It is to be noted that, with respect to the described method, modifications or improvements may be proposed without departing from the scope of the invention. For instance, it is clear that this method may be implemented in several manners, such as by means of wired electronic circuits or, alternatively, by means of a set of instructions stored in a computer-readable medium, said instructions replacing at least a part of said circuits and being executable under the control of a computer or a digital processor in order to carry out the same functions as fulfilled in said replaced circuits. The invention is thus not limited to the examples provided.

The word “comprising” does not exclude the presence of other elements or steps than those listed in a claim.

What is claimed is:

1. A method of checking a validity of a first path indicating a first resource in a network, the method comprising:
providing the first path to a server to retrieve the first resource from the network;
receiving a first response from the server;
from the first response, determining the validity of the first path; and if the first path is invalid,
(i) generating a second path from the first path, the second path being a sub-path of the first path.

2. The method of claim 1 further comprising:
(ii) providing the second path to the server to retrieve from the network a second resource indicated by the second path;
(iii) receiving a second response from the server;
(iv) from the second response, determining a validity of the second path; and, if the second path is valid,
associating the second path with a user interface element associated with the first path.

3. The method of claim 2, further comprising
if the second path is invalid,
repeating steps (i) to (iv) to determine a validity of at least a sub-path of the second
path until a specific sub-path of the second path is valid; and,
associating the specific sub-path with the user interface element.

4. The method of claim 1, wherein the first path is associated with a bookmark in a Web browser.

5. The method of claim 1, wherein the first path is associated with a link in a Web page.

6. The method of claim 1, wherein the first path comprises a series of hierarchical locations in the network and the second path is obtained by removing at least a lower hierarchical location from the first path.

7. The method of claim 2, further comprising:
replacing the first path associated with the user interface element by the second path.

8. The method of claim 1, further comprising:
causing a sound effect to represent a validity level of the first path.

9. The method of claim 1, further comprising:
causing a display of a visual effect to represent a validity level of the first path.

10. The method of claim 9, further comprising:
displaying a user interface element associated with the first path at a location on a display based on the validity level of the first path.

11. The method of claim 9, further comprising:
modifying a graphical representation of a user interface element, associated with the first path, on the basis of the validity level of the first path.

12. The method of claim 1, wherein the first path is a uniform resource identifier.

13. A computer program comprising computer readable instructions for carrying out a method of checking a validity of a first path indicating a first resource in a network, the method comprising:
providing the first path to a server to retrieve the first resource from the network;
receiving a first response from the server;
from the first response, determining the validity of the first path; and, if the first path is invalid,
(i) generating a second path from the first path, the second path being a sub-path of the first path.

14. The computer program of claim 13, wherein the method further comprises:
(ii) providing the second path to the server to retrieve from the network a second resource indicated by the second path;
(iii) receiving a second response from the server;
(iv) from the second response, determining a validity of the second path; if the second path is valid,
associating the second path with a user interface element associated with the first path.

15. The computer program of claim 14, wherein the method further comprises:
if the second path is invalid,
repeating steps (i) to (iv) to determine a validity of at least a sub-path of the second
path until a specific sub-path of the second path is valid; and,
associating the specific sub-path with the user interface element.

16. The computer program of claim 13, wherein the method further comprises:
causing a display of a visual effect to represent a validity level of the first path.

17. The computer program of claim 13, wherein the computer program is a browser.

18. The computer program of claim 13, wherein the computer program is a server.

19. A device comprising:
storage means for storing a first path indicating a first resource in a network;
validity checking means for checking a validity of the first path, the validity checking means being configured to provide the first path to a server to retrieve the first resource from the network, to receive a first response from the server and to determine the validity of the first path from the first response; and if the first path is invalid,
the validity checking means is configured to generate a second path from the first path, the second path being a sub-path of the first path.

20. The device of claim 19, wherein
the validity checking means is configured to provide the second path to the server to retrieve from the network a second resource indicated by the second path, to receive a second response from the server and to determine a validity of the second path from the second response; and, if the second path is valid,
the validity checking means is configured to associate the second path with a user interface element associated with the first path.

21. The device of claim 19, further comprising
displaying means for displaying a graphical user interface comprising the user interface element;
and wherein the validity checking means is configured to cause a visual effect on the graphical user interface to represent a validity level of the first path.
